(19) United States
(12) Patent Application Publication
(10) Pub. No.: US 2025/0109069 A1
(43) Pub. Date: Apr. 3, 2025

(54) FIRE RESISTANT GYPSUM BOARD COMPRISING SILICA FUME AND RELATED METHODS

(71) Applicant: United States Gypsum Company, Chicago, IL (US)

(72) Inventors: Qinghua LI, Rolling Meadows, IL (US); Mark Kenneth HEMPHILL, Hawthorn Woods, IL (US)

(73) Assignee: United States Gypsum Company, Chicago, IL (US)

(21) Appl. No.: 18/749,520

(22) Filed: Jun. 20, 2024

Related U.S. Application Data
(60) Provisional application No. 63/586,222, filed on Sep. 28, 2023.

(51) Int. Cl. C04B 28/14; C04B 18/14; C04B 41/53; C04B 111/00; C04B 111/10; C04B 111/12; C04B 111/34

(52) U.S. Cl. CPC C04B 28/14; C04B 18/146; C04B 41/53; C04B 2111/0062; C04B 2111/1031; C04B 2111/12; C04B 2111/34; C04B 2201/30

(57) ABSTRACT

Disclosed are gypsum boards and methods of preparing gypsum board using silica fume. The board contains a set gypsum core disposed between two cover sheets. The core is formed from a core slurry comprising water, stucco, and silica fume. The silica fume is dispersed before adding into the gypsum slurry. The gypsum board demonstrates desirable fire-resistance properties when subjected to various high temperature shrinkage and thermal insulation tests according to ASTM C1795-15. The dispersed silica fume surprisingly and unexpectedly allows for enhancing the fire resistance of gypsum board. In embodiments, the presence of the silica fume in the core slurry allows for excluding expandable vermiculite therein.

### CROSS-REFERENCE TO RELATED APPLICATION

This patent application claims the benefit of U.S. Provisional Patent Application 63/586,222, filed Sep. 28, 2023, which is incorporated by reference.

### BACKGROUND

Set gypsum is a well-known material that is used in many products, including panels and other products for building construction and remodeling. One such panel (often referred to as gypsum board) is in the form of a set gypsum layer sandwiched between two cover sheets (e.g., paper-faced board) and is commonly used in drywall construction of interior walls and ceilings of buildings. One or more dense layers, often referred to as “skim coats” can be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board).

During manufacture of the board, stucco (i.e., calcined gypsum in the form of calcium sulfate hemihydrate and/or calcium sulfate anhydrite), water, and other ingredients as appropriate are mixed in a mixer (e.g., a pin mixer known in the art). A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

One benefit of using gypsum in wallboard is that gypsum has a natural fire resistance property. Should the finished gypsum board be exposed to relatively high temperatures, such as those produced by high temperature flames or gases, portions of the set gypsum layer may absorb sufficient heat to start the release of water from the gypsum dihydrate crystals of the core. The absorption of heat and release of water from the gypsum dihydrate may be sufficient to retard heat transmission through or within the panels for a time. Gypsum board may experience shrinkage of the panel dimensions in one or more directions as one result of some or all of these high temperature heating effects, and such shrinkage may cause failures in the structural integrity of the board.

Some gypsum board products are designed to have enhanced fire resistance as compared with the property of the set gypsum alone. One example of an additive that enhances the fire resistance of gypsum board is high expansion vermiculite, which can be included in the gypsum slurry for forming the gypsum board, as described in, e.g., U.S. Pat. No. 8,323,785. One drawback is that such vermiculite can be in short supply. Such vermiculite is one of the most important additives in the formulation of fire resistant gypsum wallboard, such as ULX and ULIX (ultralight board). Typical commercial products are USG SHEETROCK® brand Firecode C and Firecode EcoSmart Type X panels.

Some fire-resistant board is considered “fire-rated” when the board passes certain tests while in an assembly of wallboards affixed to studs. The fire-ratings relate to the assembly passing certain tests, including certain tests of Underwriters Laboratories (UL), including UL tests U305, U419, and U423 (sometimes simply called UL 305, UL 419, and UL 423).

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of any embodiments of the disclosure to solve any specific problem noted herein.

### BRIEF SUMMARY

The disclosure relates to gypsum board and a method of preparing gypsum board where the board exhibits enhanced fire-resistance through the targeted use of silica fume. The gypsum board can be in the form of wallboard. As used herein, the term “wallboard” is not limited to the use of the board on walls, but can also include boards used for ceilings, partitions, etc. The board includes a set gypsum core disposed between first and second cover sheets (commonly face and back sheets, respectively). The set gypsum core is formed from a gypsum slurry comprising stucco, water, the silica fume, and optional ingredients as desired, including, for example, foaming agent, accelerator (e.g., heat resistant accelerator), retarder, strength-enhancing starch, migrating starch, and polyphosphate. The face side of the board normally is facing out and is visible when hanging in use, while the back side faces inward, toward support structures such as studs.

Surprisingly and unexpectedly, the silica fume advantageously enhances the board's performance with respect to fire-resistance, and can therefore be used as a substitute for other additives, such as vermiculite. In this regard, the present inventors have found that the use of silica fume allows for fire resistant board that avoids the need for an expensive additive, such as vermiculite, which tends to be scarce and in short supply. Further problematically, additives such as vermiculite may raise toxicity concerns as vermiculite may contain asbestos in its compositions, which has detrimental health effects. Thus, in some embodiments, the boards and methods exclude asbestos, e.g., including asbestos-containing additives. In some embodiments, the board is fire-rated when tested in an assembly as discussed herein.

Thus, in an aspect of the invention, the disclosure provides a gypsum board comprising set gypsum core disposed between two cover sheets. The core is formed from a slurry comprising stucco, water, and silica fume. In embodiments, the gypsum board described herein desirably meets at least one of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes. In various embodiments, the board passes at least two of the tests, at least three of the tests, or all four tests.

In another aspect, the disclosure provides a method of making gypsum board. The method comprises mixing a slurry comprising stucco, water, and silica fume. In embodiments, the method comprises placing the slurry between two cover sheets to form a board precursor. In addition, the method involves allowing the slurry in the precursor to set to form the board. The method also involves cutting the board. In embodiments, the gypsum board produced by the method of making described herein desirably meets at least one of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes. In various embodiments, the board passes at least two of the tests, at least three of the tests, or all four tests.

In another aspect, the disclosure provides a method of making gypsum board. The method comprises mixing a silica fume slurry comprising silica fume particles and water, wherein the silica fume is mixed into the core slurry in the form of the silica fume slurry, e.g., prepared in a high shear mixer. The method further comprises mixing a core slurry comprising stucco, water, and the silica fume slurry and placing the slurry between two cover sheets to form a board precursor. The method allows the slurry in the precursor to set to form the board before cutting the board. In embodiments, the gypsum board produced by the method of making described herein desirably meets at least one of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes. In various embodiments, the board passes at least two of the tests, at least three of the tests, or all four tests.

Further and alternative aspects and features of the disclosed principles will be appreciated from the following detailed description and the accompanying drawings. As will be appreciated, the slurries, boards, and methods disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1A is a photograph illustrating densified Silica Fume 1A, as described in Example 1.

FIG. 1B is a photograph illustrating densified Silica Fume 1B, as described in Example 1.

FIG. 2A is a photograph illustrating silica fume in dry, densified form as described in Example 1.

FIG. 2B is a photograph illustrating silica fume in liquid slurry form as described in Example 3.

FIG. 3A is a set of four Scanning Electron Microscope (“SEM”) micrographs (at magnifications of ×25, ×50, ×100, and ×10,000) illustrating densified Silica Fume 1A as described in Example 1.

FIG. 3B is a set of four SEM micrographs (at magnifications of ×25, ×50, ×100, and ×10,000) illustrating densified Silica Fume 1B as described in Example 1.

FIG. 4 is a graph of Temperature (° C.) versus Thermal Shrinkage (%) (X-Y-axis and thickness) illustrating the thermal shrinkage testing results for densified Silica Fume 1A, as described in Example 2.

FIG. 5A is a photograph illustrating a high shear mixer as described in Example 2.

FIG. 5B is a photograph illustrating sample picking of top and bottom slurry samples as described in Example 2.

FIG. 5C is a photograph illustrating an LCD digital microscope as described in Example 2.

FIG. 6A is a set of three micrographs produced by the LCD digital microscope shown in FIG. 5C (hereinafter “LCD micrographs”) illustrating top samples collected from Slurries 4A-4C, respectively, at 2500 rpm for 5 seconds, 30 seconds, and 1 minute as described in Example 4.

FIG. 6B is a set of three LCD micrographs illustrating bottom samples collected from Slurries 4A-4C, respectively, at 2500 rpm for 5 seconds, 30 seconds, and 1 minute as described in Example 4.

FIG. 7A is a set of three LCD micrographs illustrating top samples collected from Slurries 4D-4F, respectively, at 7500 rpm for 5 seconds, 30 seconds, and 1 minute as described in Example 4.

FIG. 7B is a set of three LCD micrographs illustrating bottom samples collected from Slurries 4D-4F, respectively, at 7500 rpm for 5 seconds, 30 seconds, and 1 minute as described in Example 4.

FIG. 8A is a set of three LCD micrographs illustrating top samples collected from Slurries 4G-4I, respectively, at 2500 rpm for 5 seconds, 30 seconds, and 1 minute as described in Example 4.

FIG. 8B is a set of three LCD micrographs illustrating bottom samples collected from Slurries 4G-4I, respectively, at 2500 rpm for 5 seconds, 30 seconds, and 1 minute as described in Example 4.

FIG. 9A is a set of three LCD micrographs illustrating top samples collected from Slurries 4J-4L, respectively, at 7500 rpm for 5 seconds, 30 seconds, and 1 minute as described in Example 4.

FIG. 9B is a set of three LCD micrographs illustrating bottom samples collected from Slurries 4J-4L, respectively, at 7500 rpm for 5 seconds, 30 seconds, and 1 minute as described in Example 4.

FIG. 10 is a bar graph of Thermal Shrinkage (%) in terms of Length %, Width %, and Thickness % upon heating at 900° C. for 10, 20, or 30 minutes for Boards 5A-5C as described in Example 5.

FIG. 11 is a photograph illustrating a board sample calcined at 900° C. for 30 minutes, as described in Example 6.

FIG. 12 is a bar graph of Thermal Shrinkage (%) along the x-y direction (width-length, i.e., area) and z direction (thickness) of Boards 6A-6E upon heating at 900° C., 800° C., or 650° C. for 30 minutes as described in Example 6.

FIG. 13 is a photograph illustrating board samples calcined at 650° C., 800° C., and 900° C. for 30 minutes, as described in Example 6.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of the disclosure provide a fire resistant gypsum board, as well as related slurries and methods. The gypsum board contains a set gypsum core disposed between face and back cover sheets. The set gypsum core is formed from a core slurry containing water, stucco, and other ingredients as desired. To enhance fire resistance, silica fume is included in the core slurry. In accordance with some embodiments, some fire resistant board is considered “fire-rated” when the board passes certain tests while in an assembly, as discussed below.

Surprisingly and unexpectedly, the inventors have discovered that the inclusion of the silica fume provides a significant benefit in fire resistant board as the addition of silica fume prevents the board from shrinking considerably upon heating. Such properties are beneficial because silica fume can compensate for the shrinkage of the board when exposed to heat, e.g., fire. As explored in greater detail below, shrinkage of the gypsum is undesirable since cracks will form in the board, thereby allowing fire to travel through the board.

As known in the art, one benefit of using gypsum in wallboard is gypsum's naturally occurring fire resistance properties. As discussed herein, thermal properties (e.g., fire resistance) are a measure of the ability of a gypsum board to delay flames and heat from spreading in the event of a fire. Typically, delaying the rate at which flames and heat can spread in the circumstance of a fire allows for structural supports to be protected, as well as occupants and rescue teams to escape.

Gypsum molecules contain one molecule of calcium sulfate combined with two molecules of water. The presence of water in gypsum molecules, among other things, contributes greatly to a given gypsum wallboard's natural fire resistance. In the event that a finished gypsum board is subjected to high levels of heat (e.g., such as those produced by high temperature flames or gases), portions of the set gypsum layer can absorb sufficient heat to start the release of water in the form of steam from the gypsum dihydrate crystals of the core. This process is known as calcination. Such processes help to retard heat transmission through the panel for a time.

A gypsum board may continue to act as a fire barrier should all the water escape the panel; however, conventional board may shrink due to the loss of water in the face of high heat. Shrinkage may result in cracks, which compromise and ultimately contribute to the falling apart of the board. Failure in the integrity of the board permits the passage of fire and heat into not only the constituent substrate materials of the remaining board and structure, but into rooms or areas beyond the board itself. As such, a need exists in the art to counter the shrinkage and extend the longevity of gypsum board in high temperature conditions.

Fire resistant boards can be evaluated on their ability to belay heat and/or flame in accordance with the tests described herein. In accordance with some embodiments, some fire resistant board is further considered “fire-rated” when the board passes certain tests while in an assembly, as discussed below.

Surprisingly and unexpectedly, the silica fume advantageously enhances the board's performance with respect to fire-resistance, and can therefore be used as a substitute for other additives, such as vermiculite. In this regard, the present inventors have found that the use of silica fume allows for fire resistant board that avoids the need for an expensive additive, such as vermiculite, which tends to be scarce and in short supply. Further problematically, additives such as vermiculite can raise toxicity concerns as vermiculite can contain asbestos in its compositions, which has detrimental health effects. Thus, in some embodiments, the boards and methods exclude asbestos, e.g., including asbestos-containing additives. In some embodiments, the board is fire-rated when tested in an assembly as discussed herein.

The slurry for forming the set gypsum core of the board contains water, stucco, silica fume, and optional ingredients such as foaming agent, accelerator, retarder, strength-enhancing starch, migrating starch, and other components as desired.

Stucco is sometimes referred to as calcined gypsum, and it can be in the form of calcium sulfate alpha hemihydrate, calcium sulfate beta hemihydrate, and/or calcium sulfate anhydrite. The calcined gypsum can be fibrous in some embodiments, nonfibrous in other embodiments, or a combination thereof in other embodiments. In embodiments, the calcined gypsum can include at least 50% beta calcium sulfate hemihydrate. In other embodiments, the calcined gypsum can include at least 86% beta calcium sulfate hemihydrate.

The weight ratio of water to calcined gypsum can be any suitable ratio, although, as one of ordinary skill in the art will appreciate, lower ratios can be more efficient because less excess water will remain after the hydration process of the stucco is completed during manufacture, thereby conserving energy. For example, the core slurry formulations can be made with any suitable water/stucco ratio, e.g., 0.6 to 2; 0.6 to 1.5; 0.6 to 1; 0.6 to 0.9; 0.6 to 0.85; 0.6 to 0.8; 0.6 to 0.75; 0.6 to 0.7; 0.6 to 0.65; 0.5 to 2; 0.5 to 1.5; 0.5 to 1; 0.5 to 0.9; 0.5 to 0.85; 0.5 to 0.8; 0.5 to 0.75; 0.5 to 0.7; 0.5 to 0.65; 0.4 to 2; 0.4 to 1.5; 0.4 to 1; 0.4 to 0.9; 0.4 to 0.85; 0.4 to 0.8; 0.4 to 0.75; 0.4 to 0.7; 0.4 to 0.65; 0.3 to 2; 0.3 to 1.5; 0.3 to 1; 0.3 to 0.9; 0.3 to 0.85; 0.3 to 0.8; 0.3 to 7.5; 0.3 to 0.7; 0.3 to 0.65; 0.3 to 0.5; 0.4 to 0.6; etc.

The inventors have discovered that the inclusion of silica fume provides a significant benefit in enhancing fire resistance properties of gypsum board. Silica fume (also referred to as microsilica or as “SF”) generally appears as a very fine powder, gray in color. Silica fume may be produced as a byproduct in the production of, e.g., silicon metal or alloys containing silicon (e.g., ferrosilicon alloys) in electric-arc furnaces.

With respect to its physical characteristics and chemical properties, silica fume consists primarily of amorphous silicon dioxide (SiO₂) in generally spherical particles. Silica fume is considered amorphous because, inter alia, silica fume is not a crystalline material. Generally, crystalline materials will not dissolve (e.g., sand). Silica fume particles are typically extremely small (e.g., more than 95% of silica fume particles can be less than 1 μm). In various embodiments, the silica fume particles can have an average particle diameter of 150 nm.

In embodiments, silica fume can be composed of 85% or more of SiO₂. In other embodiments, silica fume can contain various trace elements (based upon the type of fume produced). While SiO₂ can be considered the reactive material present in silica fume, various trace materials can also be present. The identification of these materials is based generally upon plant conditions including, e.g., which metal was produced in the electric-arc furnace where the silica fume was originally recovered. Generally, such latent materials are considered to have little to no impact on the performance of silica fume.

Silica fume has a very low bulk density and can be provided in at least two general states: “undensified” silica fume and “densified” densified silica fume. Undensified silica fume can have a bulk density of 200 to 350 kg/m³ while densified silica fume can have a bulk density of 450 to 700 kg/m³.

For example, the undensified silica fume can have a bulk density in a range of 200 to 350 kg/m³, such as, e.g., from 225 to 350 kg/m³; from 250 to 350 kg/m³; from 275 to 350 kg/m³; from 300 to 350 kg/m³; from 325 to 350 kg/m³; from 200 to 325 kg/m³; from 200 to 300 kg/m³; from 200 to 275 kg/m³; from 200 to 250 kg/m³; from 200 to 225 kg/m³; etc. The densified silica fume can have a bulk density in a range of 450 to 700 kg/m³, such as, e.g., from 450 to 675 kg/m³; from 450 to 650 kg/m³; from 450 to 625 kg/m³; from 450 to 600 kg/m³; from 450 to 575 kg/m³; from 450 to 550 kg/m³; from 450 to 525 kg/m³; from 450 to 500 kg/m³; from 450 to 475 kg/m³; from 475 to 700 kg/m³; from 500 to 700 kg/m³; from 525 to 700 kg/m³; from 550 to 700 kg/m³; from 575 to 700 kg/m³; from 600 to 700 kg/m³; from 625 to 700 kg/m³; from 650 to 700 kg/m³; from 675 to 700 kg/m³; etc.

The inventors have discovered that, surprisingly and unexpectedly, the inclusion of silica fume in gypsum slurries can, inter alia, significantly enhance the thermal performance (e.g., fire resistance) of the gypsum board. In some embodiments, the inclusion of silica fume in the gypsum slurry can enhance the fire resistance of gypsum board prepared without the use of vermiculite.

While not wishing to be bound by any theory, silica fume enhances the fire resistance properties of gypsum board by improving the thermal shrinkage in a fire. Surprisingly and unexpectedly, in accordance with the boards and methods of the disclosure, enhanced fire resistance is achieved without requiring additives that expand, such as vermiculite. In this respect, silica fume is believed to prevent the calcined gypsum (anhydrate) from shrinkage and cracks at high temperatures.

In some embodiments, the silica fume has a specific gravity in a range of 1.5 g/cm³ to 3.0 g/cm³. For example, the silica fume dispersant can have a specific gravity in a range from, e.g., 1.5 g/cm³ to 3.0 g/cm³; 1.5 g/cm³ to 2.9 g/cm³; 1.5 g/cm³ to 2.8 g/cm³; 1.5 g/cm³ to 2.7 g/cm³; 1.5 g/cm³ to 2.6 g/cm³; 1.5 g/cm³ to 2.5 g/cm³; 1.5 g/cm³ to 2.4 g/cm³; 1.5 g/cm³ to 2.3 g/cm³; 1.5 g/cm³ to 2.2 g/cm³; 1.5 g/cm³ to 2.1 g/cm³; 1.5 g/cm³ to 2.0 g/cm³; 2.0 g/cm³ to 3.0 g/cm³; 2.1 g/cm³ to 3.0 g/cm³; 2.2 g/cm³ to 3.0 g/cm³; 2.3 g/cm³ to 3.0 g/cm³; 2.4 g/cm³ to 3.0 g/cm³; 2.5 g/cm³ to 3.0 g/cm³; etc. In some embodiments, the specific gravity is 2.2 g/cm³.

The silica fume particles can have any suitable surface area. For example, in some embodiments, the silica fume has a specific surface area in a range of 15,000 to 30,000 m²/kg in accordance with the Brunauer-Emmett-Teller (BET) method. As known in the art, the BET method is used, among other things, to measure the surface area of solid and/or porous materials, for example, as described in, e.g., U.S. Patent Publication 2020/00317537 A1.

For example, the silica fume can have a specific surface area measured in accordance with the BET method in a range from, e.g., 15,000 to 30,000 m²/kg; 16,000 to 30,000 m²/kg; 17,000 to 30,000 m²/kg; 18,000 to 30,000 m²/kg; 19,000 to 30,000 m²/kg; 20,000 to 30,000 m²/kg; 21,000 to 30,000 m²/kg; 22,000 to 30,000 m²/kg; 23,000 to 30,000 m²/kg; 24,000 to 25,000 m²/kg; 26,000 to 30,000 m²/kg; 27,000 to 30,000 m²/kg; 28,000 to 30,000 m²/kg; 29,000 to 30,000 m²/kg; 15,000 to 29,000 m²/kg; 15,000 to 28,000 m²/kg; 15,000 to 27,000 m²/kg; 15,000 to 26,000 m²/kg; 15,000 to 25,000 m²/kg; 15,000 to 24,000 m²/kg; 15,000 to 23,000 m²/kg; 15,000 to 22,000 m²/kg; 15,000 to 21,000 m²/kg; 15,000 to 20,000 m²/kg; etc.

In some embodiments, the silica fume is provided in an amount of from 0.1% to 10% by weight of the stucco, e.g., from 0.5% to 7%, or from 1% to 5%. In some embodiments, the silica fume is added to the slurry in a solution containing less than 60% silica fume, e.g., from 30% to 50% silica fume, such as from 25% to 45% silica fume.

Commercially available examples of silica fume include densified silica fume and undensified silica fume, respectively, produced by Norchem, Inc., headquartered in Hauppauge, New York, and Elkem Microsilica® 920 and Elkem Microsilica® 940, which is a densified silica fume, produced by Elkem ASA, headquartered in Oslo, Norway.

According to embodiments of the disclosure, it has been discovered that, surprisingly and unexpectedly, the inclusion of silica fume can enhance the fire-resistance of gypsum board.

As understood in the art, silica fume is distinguished from “fumed silica” (sometimes referred to as pyrogenic silica) since the two materials demonstrate different chemical, physical, and performance properties. For example, silica fume and fumed silica are formed under different conditions and settings. As described above, silica fume may be collected as a byproduct in the production of, e.g., silicon metal or ferrosilicon alloys in electric-arc furnaces. Fumed silica (as referred to as pyrogenic silica) is produced in a flame. Thus, the structure and makeup of fumed silica differs from silica fume; for example, fumed silica may consist of microscopic droplets of amorphous silica fused into branched, chainlike, three-dimensional secondary particles. These particles, among other things, may agglomerate into tertiary particles. As a result, fumed silica is generally used for certain rheological applications (e.g., increasing the viscosity of slurries as a thickening or anticaking agent).

The silica fume can be added to the gypsum slurry in dry (e.g., powder) or wet (e.g., suspended or dissolved in a liquid medium) form(s). In wet form (i.e., diluted form), the active content of the silica fume can be any suitable amount.

In accordance with aspects of the present disclosure, a silica slurry can be prepared separately from the gypsum slurry. The silica fume slurry can include, for example, dry densified silica fume mixed with water. In one embodiment, the slurry can comprise of 10-50% silica fume. In another embodiment, the slurry can comprise of 15-20% silica fume. It will be understood that efficiency of the silica fume is determined by normalizing the amount to the active content (e.g., when comparing a dry, i.e., 100%, form as compared with a wet, diluted form where the active content will be less than 100%).

For example, in some embodiments, the active content is 50% or less, e.g., 10%-50%; 15%-50%; 25%-45%; 30%-40%; etc. In some embodiments, the active content is 16.7%. It will be understood that efficiency of the silica fume is determined by normalizing the amount to the active content (e.g., when comparing a dry, i.e., 100%, form as compared with a wet, diluted form where the active content will be less than 100%).

In an aspect, a silica fume slurry is mixed prior to combining the silica fume with the core slurry. The silica fume slurry comprises silica fume particles and water. The silica fume slurry is then mixed into the core slurry.

In embodiments of the present disclosure, the silica fume slurry is prepared in a high shear mixer at an rpm of 2500. Examples of high shear mixers may include Ross high shear mixers, progressive cavity pumps, etc.

In accordance with embodiments of the disclosure, inclusion of the silica fume imparts added fire resistance property to the set gypsum layer in the gypsum board, while allowing for reduction or elimination of the use of expandable vermiculite. The set gypsum layer formed from a gypsum slurry that includes the silica fume has a fire resistance greater than an equivalent set gypsum layer formed from a slurry that does not include the silica fume.

However, if desired, expandable vermiculite can be included. For example, expandable vermiculite (sometimes referred to as unexpanded vermiculite) is described in, e.g., U.S. Pat. No. 8,323,785, which discussion is incorporated by reference herein. Any suitable type of expandable vermiculite can be included. Expandable vermiculite in some embodiments is a high expansion vermiculite. High expansion vermiculite particles have a volume expansion after heating for one hour at about 1560° F. (about 850° C.) of about 300% or more of their original volume.

In some embodiments, the gypsum board is essentially free of an unexpanded vermiculite. In some embodiments, the gypsum board is essentially free of any additional high expansion particulate (besides silica fume). Essentially free of any of the aforementioned ingredients means that the gypsum slurry contains either (i) 0 wt. % based on the weight of any of these ingredients, or (ii) an ineffective or (iii) an immaterial amount of any of these ingredients. An example of an ineffective amount is an amount below the threshold amount to achieve the intended purpose of using any of these ingredients, as one of ordinary skill in the art will appreciate. An immaterial amount can be, e.g., below about 0.1 wt. %, such as below about 0.05 wt. %, below about 0.02 wt. %, below about 0.01 wt. %, etc., based on the weight of stucco, as one of ordinary skill in the art will appreciate.

In some embodiments, additional fire resistant additives optionally can be included in the gypsum slurry for forming the board, including non-expanding materials. For example, the additional fire resistant additives can include fiber, e.g., glass fiber, carbon fiber, or mineral fiber; alumina trihydrate (ATH); clay; and the like. Fiber can be beneficial because it helps to improve board integrity. ATH can provide flame retardance and is further beneficial because its heat absorption capacity is higher than that of gypsum. If included, these additives can be present in the gypsum slurry in an amount of from about 0% to about 20% by weight of the stucco, e.g., from about 0% to about 15% by weight of stucco, from about 0% to about 10% by weight of stucco, from about 1% to about 8% by weight of stucco, etc.

Expandable graphite can be added. Examples of commercially available expandable graphite products include GRAFGUARD 160-50N, having an onset temperature of 320° F. (160° C.), a mesh size of 50, and a neutral surface chemistry; as well as GRAFGUARD 220-50N, having an onset temperature of 430° F. (220° C.), a mesh size of 50, and a neutral surface chemistry; GRAFGUARD 220-80N, having an onset temperature of 430° F. (220° C.), a mesh size of 80, and a neutral surface chemistry; GRAFGUARD 250-50N, having an onset temperature of 480° F. (250° C.), a mesh size of 50, and a neutral surface chemistry. The GRAFGUARD products are commercially available from GrafTech International, Independence, OH.

Foaming agent can also be included in the core slurry to introduce air voids into the set gypsum core to reduce board weight. The foaming agent can be added by addition in a primary discharge conduit of the main board mixer. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness can be effective to enhance strength, especially in lower density board (e.g., 35 pcf or less). See, e.g., U.S. Pat. Nos. 9,802,866 and 9,840,066. Evaporative water voids, generally having voids of 5 μm or less in diameter, also contribute to the total void distribution along with the aforementioned air (foam) voids.

Strength-enhancing starch can optionally be included in the core slurry. Such a starch improves the strength of the board (e.g., with respect to nail pull strength) as compared with the same board excluding the starch. Starches for strength enhancement are discussed in, e.g., U.S. Pat. Nos. 9,540,810, 9,828,441, 10,399,899, and 10,919,808. Any suitable strength-enhancing starch can be used, including hydroxyalkylated starches such as hydroxyethylated or hydroxypropylated starch, or a combination thereof; a pregelatinized starch; or an uncooked, non-migrating, starch.

Any suitable pregelatinized starch can be included in the core slurry, as described in U.S. Pat. Nos. 10,399,899 and 9,828,441, including methods of preparation thereof and desired viscosity ranges described therein. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In other embodiments, the pregelatinized starch has a greater viscosity, such as greater than 700 centipoise (e.g., 773 centipoise) according to the VMA test.

In some embodiments, the starch includes an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute as described in U.S. Pat. No. 10,919,808.

For example, in some embodiments, the strength-enhancing starch includes an uncooked medium hydrolyzed acid modified starch (e.g., an uncooked acid-modified corn starch having a hot water viscosity of 180 BU); and/or a medium viscosity and medium molecular weight pregelatinized starch (e.g., pregelatinized corn flour starch with a cold water viscosity of 90 centipoise).

Strength-enhancing starches differ from migrating starches such as LC-211, commercially available from Archer-Daniels-Midland, Chicago, Illinois. Migrating starches normally have smaller chain lengths (e.g., due to acid- or enzyme-modification) and migrate to the core-cover sheet interface for further bond enhancement. For example, in some embodiments, the core slurry includes a migrating starch having a molecular weight of 6,000 Daltons or less.

If included, the optional strength-enhancing starch can be included in the core slurry in any suitable amount. For example, in some embodiments, the core slurry comprises a strength-enhancing starch in an amount of at least 0.5% by weight of the stucco (e.g., from 0.5% to 5% by weight of the stucco, such as from 0.5% to 3%, from 1% to 5%, from 1% to 3%, from 2% to 5%, from 2% to 4%, from 2% to 3%, by weight of the stucco, etc.). In some embodiments, the core slurry is substantially free of a strength-enhancing starch, e.g., having 2% or less by weight of stucco, such as 1% or less by weight of the stucco.

Other additives can be included in the core slurry. Such additives include structural additives, including mineral wool, perlite, clay, calcium carbonate, and chemical additives, including fillers, sugar, enhancing agents (such as phosphonates, borates and the like), binders (such as latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Pat. Nos. 7,244,304; 7,364,015; 7,803,226; 7,892,472; 6,342,284; 6,632,550; 6,800,131; 5,643,510; 5,714,001; and 6,774,146; and U.S. Patent Application Publication 2002/0045074. Other examples of such additives include fire-rated and/or water resistant product that can also optionally be included in the core slurry, include e.g., siloxanes (water resistance); heat sink additives such as aluminum trihydrate (ATH), magnesium hydroxide or the like; and/or high expansion particles (e.g., expandable to 300% or more of original volume when heated for about one hour at 1560° F.). See, e.g., U.S. Pat. No. 8,323,785 for description of these and other ingredients. In some embodiments, high expansion vermiculite is included, although other fire resistant materials can be included.

The core slurry can include accelerator and/or retarder. Accelerator (e.g., wet gypsum accelerator, heat resistant accelerator, climate stabilized accelerator) and retarder are well known and can be included in the core slurry, if desired. See, e.g., U.S. Pat. Nos. 3,573,947 and 6,409,825. In some embodiments where accelerator and/or retarder are included, the accelerator and/or retarder each can be in the core slurry in an amount on a solid basis of, such as, from 0% to 10% by weight of the stucco (e.g., 0.1% to 10%), such as, for example, from 0% to 5% by weight of the stucco (e.g., 0.1% to 5%).

Polyphosphate can optionally be included in the core slurry, e.g., in order to enhance sag resistance in the board. Trimetaphosphate compounds can be used, including, for example, sodium trimetaphosphate, potassium trimetaphosphate, lithium trimetaphosphate, and ammonium trimetaphosphate.

With respect to the polyphosphate (e.g., sodium trimetaphosphate), the core slurry can include it in any suitable amount, e.g., from 0.01% to 0.5% by weight of the stucco, from 0.01% to 0.4%; from 0.05% to 0.3%; from 0.1% to 0.5%; from 0.1% to 0.4%; from 0.1% to 0.3%; from 0.1% to 0.2%; from 0.15% to 0.5%; from 0.2% to 0.4%; from 0.05% to 0.5%; by weight of the stucco, etc.

The cover sheets can also have any suitable total thickness. In some embodiments, at least one of the cover sheets has a relatively high thickness, e.g., a thickness of at least about 0.014 inches. In some embodiments, it is preferred that there is an even higher thickness, e.g., at least about 0.015 inches, at least about 0.016 inches, at least about 0.017 inches, at least about 0.018 inches, at least about 0.019 inches, at least about 0.020 inches, at least about 0.021 inches, at least about 0.022 inches, or at least about 0.023 inches. Any suitable upper limit for these ranges can be adopted, e.g., an upper end of the range of about 0.030 inches, about 0.027 inches, about 0.025 inches, about 0.024 inches, about 0.023 inches, about 0.022 inches, about 0.021 inches, about 0.020 inches, about 0.019 inches, about 0.018 inches, etc. The total sheet thickness refers to the sum of the thickness of each sheet attached to the gypsum board.

The cover sheets can have any suitable density. For example, in some embodiments, at least one or both of the cover sheets has a density of at least about 36 pcf, e.g., from about 36 pcf to about 46 pcf; such as from about 36 pcf to about 44 pcf; from about 36 pcf to about 42 pcf; from about 36 pcf to about 40 pcf; from about 38 pcf to about 46 pcf; from about 38 pcf to about 44 pcf; from about 38 pcf to about 42 pcf; etc.

The cover sheet can have any suitable weight. For example, in some embodiments, lower basis weight cover sheets (e.g., formed from paper) such as, for example, at least about 33 lbs/MSF (e.g., from about 33 lbs/MSF to about 65 lbs/MSF, from about 33 lbs/MSF to about 60 lbs/MSF, 33 lbs/MSF to about 58 lbs/MSF from about 33 lbs/MSF to about 55 lbs/MSF, from about 33 lbs/MSF to about 50 lbs/MSF, from about 33 lbs/MSF to about 45 lbs/MSF, etc., or less than about 45 lbs/MSF) can be utilized in some embodiments. In other embodiments, one or both cover sheets has a basis weight from about 38 lbs/MSF to about 65 lbs/MSF, from about 38 lbs/MSF to about 60 lbs/MSF, from about 38 lbs/MSF to about 58 lbs/MSF, from about 38 lbs/MSF to about 55 lbs/MSF, from about 38 lbs/MSF to about 50 lbs/MSF, from about 38 lbs/MSF to about 45 lbs/MSF, etc.

However, if desired, in some embodiments, even heavier basis weights can be used, e.g., to further enhance nail pull resistance or to enhance handling, e.g., to facilitate desirable “feel” characteristics for end-users. Thus, one or both of the cover sheets can have a basis weight of, for example, at least about 45 lbs/MSF (e.g., from about 45 lbs/MSF to about 65 lbs/MSF, from about 45 lbs/MSF to about 60 lbs/MSF, from about 45 lbs/MSF to about 55 lbs/MSF, from about 50 lbs/MSF to about 65 lbs/MSF, from about 50 lbs/MSF to about 60 lbs/MSF, etc.). If desired, in some embodiments, one cover sheet (e.g., the “face” paper side when installed) can have the aforementioned higher basis weight, e.g., to enhance nail pull resistance and handling, while the other cover sheet (e.g., the “back” sheet when the board is installed) can have somewhat lower weight basis if desired (e.g., weight basis of less than about 60 lbs/MSF, e.g., from about 33 lbs/MSF to about 55 lbs/MSF, from about 33 lbs/MSF to about 50 lbs/MSF, from about 33 lbs/MSF to about 45 lbs/MSF, from about 33 lbs/MSF to about 40 lbs/MSF, etc.).

In some embodiments, the gypsum board can pass certain tests using a small scale bench test, in accordance with ASTM C1795-15, including high temperature shrinkage in the x-y directions (width-length), high temperature shrinkage (or even expansion) in the z-direction (thickness), and a Thermal Insulation Index (TI). Such bench tests are suitable for predicting the fire resistance performance of the gypsum board, e.g., in full scale tests under ASTM E119-09a for assemblies constructed under any of UL U305, U419, and/or U423 (2015 editions), and/or equivalent fire test procedures and standards. Passing the ASTM E119-09a test with the assembly of any one of these UL tests allows for a fire-rating. Briefly, UL U305 calls for wood studs in the assembly. UL U419 is a non-load bearing metal stud assembly, using 25 gauge studs. UL U423 is a load bearing metal stud assembly using 20 gauge studs. UL U419 is generally considered a more difficult test to pass than UL U305 or UL U423 because it uses light gauge steel studs that deform more easily than the studs used under UL U305 and UL U423.

In accordance with some embodiments, gypsum board is configured (e.g., as reduced weight and density, ⅝ inch thick gypsum panels) to meet or exceed a “one hour” fire rating pursuant to the fire containment and structural integrity requirements of assemblies constructed under one or more of UL U305, U419, and/or U423, using ASTM E119 and/or equivalent fire test procedures and standards. The present disclosure thus provides gypsum board (e.g., of reduced weight and density), and methods for making the same, that are capable of satisfying at least ¾ hour fire rating pursuant to the fire containment and structural integrity procedures and standards U419.

The gypsum board can be tested, e.g., in an assembly according to Underwriters Laboratories UL U305, U419, and U423 specifications and any other fire test procedure that is equivalent to any one of those fire test procedures. It should be understood that reference made herein to a particular fire test procedure of ASTM E-119 and using assemblies prepared in accordance with Underwriters Laboratories, such as, UL U305, U419, and U423, for example, also includes a fire test procedure, such as one promulgated by any other entity, that is equivalent to ASTM E119-09a and the particular UL standard in question.

Gypsum board according to some embodiments of the present disclosure is effective to withstand the hose stream test also conducted as part of the UL U305 procedures. In accordance with UL U305, gypsum board of some embodiments constructed in an assembly is subjected to fire endurance testing according to U305 for 30 minutes, at which time it is pulled from the heating environment and moved to another location for the hose stream test according to U305. The assembly is subjected to a stream of water from a fire hose equipped to send the water out at about 30 psi water pressure for a sixty second duration.

By extension, gypsum board formed according to principles of some embodiments of the present disclosure can be used in assemblies that are effective to inhibit the transmission of heat there through to meet the one-hour fire-resistance rating to be classified as Type X board under ASTM 1396/C 1396M-06. In other embodiments, assemblies can be constructed using gypsum board formed according to principles of the present disclosure that conform to the specification of other UL assemblies, such as UL U419 and U423, for example. In yet other embodiments, gypsum board formed according to principles of the present disclosure can be used in other assemblies that are substantially equivalent to at least one of U305, U419, and U423. Such assemblies can pass the one-hour fire rating and applicable hose stream testing for U305, U419, U423, and other equivalent fire test procedures in accordance with some embodiments.

In some embodiments, the High Temperature Shrinkage according to ASTM C1795-15 of the gypsum board typically is about 10% or less in the x-y directions (width-length), e.g., about 8% or less, about 6% or less, about 4% or less, about 2% or less, about 1% or less, etc.

With respect to the thickness of the board, i.e., the z-direction, the board can shrink to a relatively small degree (e.g., about 10% or less).

Thus, in some embodiments, the High Temperature Shrinkage of the gypsum board in the z-direction can be about 10% or less, e.g., about 9% or less, about 8% or less, about 7% or less, about 5% or less, about 3% or less, about 2% or less, about 1% or less, etc. For example, the High Temperature Shrinkage of the gypsum board in the z-direction can be from about 0.1% to about 10%, e.g., from about 0.1% to about 9%, from about 0.1% to about 8%, from about 0.1% to about 7%, from about 0.1% to about 5%, from about 0.5% to about 10%, from about 0.5% to about 5%, from about 1% to about 10%, from about 1% to about 8%, from about 1% to about 5%, from about 5% to about 10%, or from about 5% to about 8%.

With respect to gypsum board containing vermiculite in accordance with some embodiments, board that has a High Temperature Shrinkage of about 10% or less in the z direction that the board will pass one or more fire tests according to ASTM E119 using the assemblies constructed according to UL U305, U419, and U423, and the board will thus be fire-rated.

“Shrink resistance” is a measure of the proportion or percentage of the x-y (width-length) area of a segment of core that remains after the core is heated to a defined temperature over a defined period of time (see, e.g., U.S. Pat. No. 3,616,173). In some embodiments, a gypsum board formed according to principles of some embodiments of the present disclosure, and the methods for making same, can provide a board that exhibits an average shrink resistance of about 85% or greater (e.g., about 90% or greater, or about 95% or greater) when heated at about 1560° F. (850° C.) for one hour in accordance with ASTM C1795-15. In other embodiments, the gypsum board exhibits an average shrink resistance of about 75% or greater (e.g., about 80% or greater) when heated at about 1560° F. (850° C.) for one hour in accordance with ASTM C1795-15.

The gypsum layers between the cover sheets of some embodiments can be effective to provide a Thermal Insulation Index (TI) of about 17 minutes or greater, e.g., about 20 minutes or greater, in accordance with ASTM C1795-15. The gypsum layers can have any suitable density (D), e.g., as described herein. In some embodiments, the gypsum board has a reduced density, e.g., about 40 pcf or less, about 39 pcf or less, about 38 pcf or less, about 37 pcf or less, about 36 pcf or less, about 35 pcf or less, etc.). Some embodiments of the present disclosure allow for suitable fire resistance properties at such lower densities. The gypsum layers between the cover sheets can be effective in some embodiments to provide the gypsum board or any layer therein with a ratio of TI/D of about 0.6 minutes/pounds per cubic foot (about 0.038 minutes/(kg/m3)) or more.

The board can have any desired thickness, such as from about 0.25 inch to about one inch (e.g., about 0.25 inch, about 0.375 inch, about 0.5 inch, about 0.625 inch, about 0.75 inch, about one inch, etc.). Desirably, the board has good strength as described herein, such as an average gypsum layer hardness of at least about 11 pounds (5 kg), e.g., at least about 13 pounds (5.9 kg), or at least about 15 pounds (6.8 kg).

In some embodiments, the board has a nominal thickness of about ⅝ inch. For example, the gypsum board in some embodiments is effective to inhibit the transmission of heat through an assembly constructed in accordance with any one of UL Design Numbers U305, U419 or U423, the assembly having a first side with a single layer of gypsum boards and a second side with a single layer of gypsum boards. ASTM E119-09a involves placing thermocouples in numerous places throughout a particular assembly. The thermocouples then monitor temperature as the assembly is exposed to heat over time. In this respect, surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a. ASTM E119 specifies that the assembly fails the test if any of the thermocouples exceeds a certain preset temperature (ambient plus 325° F.), or if the average of the temperatures from the thermocouples exceeds a different preset temperature (ambient plus 250° F.).

In some embodiments of gypsum board, when heated, the maximum single value of the temperature sensors is less than about 325° F. plus ambient temperature after about 50 minutes, and/or or the average value of the temperature sensors is less than about 250° F. plus ambient temperature after about 50 minutes. In some embodiments, the board has a density of about 40 pounds per cubic foot or less.

In some embodiments, when the surfaces on the first side of the assembly of gypsum board are heated, the maximum single value of the temperature sensors is less than about 325° F. plus ambient temperature after about 55 minutes, and/or the average value of the temperature sensors is less than about 250° F. plus ambient temperature after about 55 minutes. In other embodiments, when the surfaces of gypsum board on the first side of the assembly are heated, the maximum single value of the temperature sensors is less than about 325° F. plus ambient temperature after about 60 minutes and/or the average value of the temperature sensors is less than about 250° F. plus ambient temperature after about 60 minutes. In other embodiments, when the surfaces of gypsum board on the first side of the assembly are heated, the maximum single value of the temperature sensors is less than about 325° F. plus ambient temperature after about 50 minutes, and/or the average value of the temperature sensors is less than about 250° F. plus ambient temperature after about 50 minutes. In other embodiments, when the surfaces of gypsum board on the first side of the assembly are heated, the maximum single value of the temperature sensors is less than about 325° F. plus ambient temperature after about 55 minutes, and/or the average value of the temperature sensors is less than about 250° F. plus ambient temperature after about 55 minutes. In other embodiments, when the surfaces of gypsum board on the first side of the assembly are heated, the maximum single value of the temperature sensors is less than about 325° F. plus ambient temperature after about 60 minutes, and the average value of the temperature sensors is less than about 250° F. plus ambient temperature after about 60 minutes.

In some embodiments, the gypsum board is effective to inhibit the transmission of heat through the assembly when constructed in accordance with UL Design Number U305 so as to achieve a one hour fire rating under ASTM E119-09a. In some embodiments, the board is effective to inhibit the transmission of heat through the assembly when constructed in accordance with UL Design Number U419 so as to achieve a one hour fire rating under ASTM E119-09a. In some embodiments, the gypsum board is effective to inhibit the transmission of heat through the assembly when constructed in accordance with UL Design Number U423 so as to achieve a one hour fire rating under ASTM E119-09a. In some embodiments, the board has a Thermal Insulation Index (TI) of about 20 minutes or greater and/or a High Temperature Shrinkage(S) of about 10% or less, in accordance with ASTM C1795-15. In some embodiments, the board has a ratio of High Temperature Thickness Expansion (TE) to S (TE/S) of about 0.06 or more, such as about 0.2 or more.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets can vary slightly as well understood in the art.

Board weight is a function of the thickness of the board. Since boards are commonly made at varying thicknesses, board density is used herein as a measure of board weight. Examples of suitable nominal thickness include about ¼ inch, about ⅜ inch, about ½ inch, about ⅝ inch, about ¾ inch, or about one inch, and any range using any of the foregoing as endpoints. In some markets, the board can be formed at a nominal thickness according to metric measurements, e.g., about 9 mm, about 9.5 mm, about 10 mm, about 12 mm, about 12.5 mm, about 13 mm, about 15 mm, about 25 mm, and any range using any of the foregoing as endpoints. Properties referenced herein can be seen in board formed at one or more of the previously mentioned board thicknesses according to various embodiments. The advantages of the gypsum board in accordance with embodiments of the disclosure can be seen at a range of densities, including up to heavier board densities, e.g., about 43 pcf or less, or 40 pcf or less, such as from about 17 pcf to about 43 pcf, from about 20 pcf to about 43 pcf, from about 24 pcf to about 43 pcf, from about 27 pcf to about 43 pcf, from about 20 pcf to about 40 pcf, from about 24 pcf to about 40 pcf, from about 27 pcf to about 40 pcf, from about 20 pcf to about 37 pcf, from about 24 pcf to about 37 pcf, from about 27 pcf to about 37 pcf, from about 20 pcf to about 35 pcf, from about 24 pcf to about 35 pcf, from about 27 pcf to about 35 pcf, etc.

The dense layer(s) has a considerably greater density than the density of the board core. For example, the dense layer can have a density of from 40 pcf to 70 pcf (e.g., from 45 pcf to 65 pcf, or from 50 pcf to 60 pcf).

The core can have any suitable density but lesser densities can be used, e.g., a core density of 35 pcf or less (e.g., 31 pcf or less, or 27 pcf or less). For example, the core can have a density of from 15 pcf to 35 pcf (e.g., from 20 pcf to 31 pcf, from 20 pcf to 24 pcf, or from 24 pcf to 27 pcf, etc.).

The board can be prepared in any suitable manner. In embodiments, a main mixer containing an agitator as understood in the art is used at a wet end of a manufacturing line as also understood in the art. The agitator can be in the form of pins, disk, impeller, propeller, rotor spinning inside a stationary housing, or the like. The main mixer can be used to prepare a core and dense slurry, respectively. Stucco, water, and optionally, an additive package are inserted into the main mixer. The mixer contains a primary discharge conduit and a secondary discharge conduit. Slurry is discharged from the primary discharge conduit where core additives such as foam (see, e.g., U.S. Pat. No. 5,683,635) are inserted to form a core slurry. Slurry can be released from the secondary discharge conduit to form a dense layer slurry (e.g., with less or no foaming agent as compared with the core slurry).

A first moving cover sheet (e.g., over a moving conveyor) is provided. The board is generally formed upside down at the wet end of the plant such that the first moving cover sheet is generally the face cover sheet, although this is not mandatory. The dense layer slurry is deposited over the moving cover sheet. The core slurry is deposited over the dense layer. A second moving cover sheet (e.g., the back paper) is applied over the core slurry layer to form a sandwich structure of a board precursor. In embodiments, the dense layer slurry is deposited onto the moving cover sheet upstream of the mixer, while the core slurry is deposited over the cover sheet bearing the dense layer, downstream of the mixer. In some embodiments, the secondary discharge conduit is disposed on the mixer upstream of the primary discharge conduit to conveniently accommodate this arrangement of depositing the layers relative to the positioning of the mixer.

If desired, it will be understood that the board can be prepared using two separate mixers equipped with agitators, with one mixer dedicated for preparing the core slurry and the other mixer dedicated for preparing the core slurry. As such, each of the dense layer and core slurries can be separately formulated and discharged out of each mixer and then applied to form the board as described herein.

After the sandwich structure of the board precursor is formed at the wet end of the manufacturing line, the board precursor sets as it travels, e.g., by conveyor, to other stations, including a knife, where the board precursor is cut into segments. The board can then be flipped and dried in a kiln to form the final board product and processed at the dry end of the manufacturing line, e.g., to a final size, as understood by one of ordinary skill in the art. Arrangements for producing the board are described in, e.g., U.S. Pat. Nos. 5,683,635; 6,494,609; 6,874,930; and 7,364,676 and U.S. Patent Application Publications 2010/0247937; 2012/0168527; and 2012/0170403.

The disclosure is further illustrated by the following exemplary aspects. However, the disclosure is not limited by the following aspects.

(1) A gypsum board or method of preparing board, as described herein.

(2) A gypsum board comprising: a set gypsum core disposed between two cover sheets, the core formed from a core slurry comprising water, stucco, and silica fume; the gypsum board meeting at least one or more of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

(3) The gypsum board of aspect 2, wherein the slurry is substantially free from vermiculite.

(4) The gypsum board of aspects 2 or 3, wherein the silica fume is added to the slurry in the form of a silica fume slurry comprising water and silica fume particles.

(5) The gypsum board of aspect 4, wherein the silica fume particles have an average particle diameter of from 1000 nm to 50 nm, such as from 500 nm to 100 nm, e.g., 150 nm.

(6) The gypsum board of aspects 4 or 5, wherein the silica fume slurry contains from 10% to 50% silica fume, e.g., from 20% to 35% silica fume, such as from 15% to 20% silica fume.

(7) The gypsum board of any one of aspects 4-6, wherein 95% of the silica fume particles have a diameter of 1 μm or less.

(8) The gypsum board of any one of aspects 2-7, wherein the silica fume comprises undensified silica fume.

(9) The gypsum board of aspect 8, wherein the undensified silica fume has a bulk density of from 100 kg/m³ to 500 kg/m³, e.g., from 200 kg/m³ to 350 kg/m³, such as from 150 kg/m³ to 300 kg/m³.

(10) The gypsum board of any one of aspects 2-9, wherein the silica fume comprises densified silica fume.

(11) The gypsum board of aspect 10, wherein the densified silica fume has a bulk density of from 500 kg/m³ to 900 kg/m³, e.g., from 450 kg/m³ to 800 kg/m³, such as from 600 kg/m³ to 700 kg/m³.

(12) The gypsum board of any one of aspects 2-11, wherein the core slurry contains silica fume in an amount of from 1% to 15% by weight of stucco, such as from 2% to 10% by weight of stucco, or from 3% to 5% by weight of stucco.

(13) The gypsum board of any one of aspects 2-12, wherein the core slurry is free of lime.

(14) The gypsum board of any one of aspects 2-12, wherein the core slurry is free of asbestos.

(15) A method of making gypsum board, the method comprising: mixing a core slurry comprising stucco, water, and silica fume; placing the slurry between two cover sheets to form a board precursor; allowing the slurry in the precursor to set to form the board; and cutting the board, wherein the board meets at least one or more of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

(16) The method of aspect 15, further comprising mixing a silica fume slurry comprising silica fume particles and water, wherein the silica fume is mixed into the core slurry in the form of the silica fume slurry, e.g., prepared in a high shear mixer.

(17) The method of aspect 16, wherein the silica fume slurry is mixed under high shear of at least the shear produced in a ROSS HSM 100 LC mixer set at 2500 rpm after 5 seconds.

(18) The method of aspects 16 or 17, wherein the silica fume particles have an average particle diameter of from 1000 nm to 50 nm, such as from 500 nm to 100 nm, e.g., 150 nm.

(19) The method of any one of aspects 16-18, wherein the silica fume slurry contains from 10% to 50% silica fume, e.g., from 20% to 35% silica fume, such as from 15% to 20% silica fume.

(20) The method of any one of aspects 16-19, wherein 95% of the silica fume particles have a diameter of 2 μm or less, such as a diameter of 1 μm or less, e.g., a dimeter of 0.5 μm to 0.1 μm, or a diameter of 0.3 μm to 0.1 μm.

(21) The method of any one of aspects 15-20, wherein the silica fume comprises undensified silica fume.

(22) The method of aspect 21, wherein the undensified silica fume has a bulk density of from 100 kg/m³ to 500 kg/m³, e.g., from 200 kg/m³ to 350 kg/m³, such as from 150 kg/m³ to 300 kg/m³.

(23) The method of any one of aspects 15-22, wherein the silica fume comprises densified silica fume.

(24) The method of aspect 23, wherein the densified silica fume has a bulk density of from 500 kg/m³ to 900 kg/m³, e.g., from 450 kg/m³ to 800 kg/m³, such as from 600 kg/m³ to 700 kg/m³.

(25) The method of any one of aspects 15-24, wherein the core slurry contains silica fume in an amount of from 1% to 15% by weight of stucco, such as from 2% to 10% by weight of stucco, or from 3% to 5% by weight of stucco.

(26) The method of any one of aspects 15-25, wherein the core slurry is free of lime.

(27) The method of any one of aspects 15-25, wherein the core slurry is free of asbestos.

(28) A method of making gypsum board, the method comprising: mixing a silica fume slurry comprising silica fume particles and water, wherein the silica fume is mixed into the core slurry in the form of the silica fume slurry, e.g., prepared in a high shear mixer; mixing a core slurry comprising stucco, water, and the silica fume slurry; placing the slurry between two cover sheets to form a board precursor; allowing the slurry in the precursor to set to form the board; and cutting the board, wherein the board meets at least one or more of the following tests (a)-(d): (a) a High Temperature Shrinkage(S) of about 10% or less in the z direction when heated to about 1560° F. (850° C.), according to ASTM C1795-15; (b) a High Temperature Shrinkage(S) of about 10% or less in the x-y directions (width-length) when heated to about 1560° F. (850° C.) according to ASTM C1795-15; (c) a Thermal Insulation Index (TI) of about 20 minutes or greater according to ASTM C1795-15; and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

(29) The method of aspect 28, wherein the silica fume slurry is mixed under high shear of at least the shear produced in a ROSS HSM 100 LC mixer set at 2500 rpm after 5 seconds.

(30) The method of aspects 28 or 29, wherein the silica fume particles have an average particle diameter of from 1000 nm to 50 nm, such as from 500 nm to 100 nm, e.g., 150 nm.

(31) The method of any one of aspects 28-30, wherein the silica fume slurry contains from 10% to 50% silica fume, e.g., from 20% to 35% silica fume, such as from 15% to 20% silica fume.

(32) The method of any one of aspects 28-31, wherein 95% of the silica fume particles have a diameter of 2 μm or less, such as a diameter of 1 μm or less, e.g., a dimeter of 0.5 μm to 0.1 μm, or a diameter of 0.3 μm to 0.1 μm.

(33) The method of any one of aspects 28-32, wherein the silica fume comprises undensified silica fume.

(34) The method of aspect 33, wherein the undensified silica fume has a bulk density of from 100 kg/m³ to 500 kg/m³, e.g., from 200 kg/m³ to 350 kg/m³, such as from 150 kg/m³ to 300 kg/m³.

(35) The method of any one of aspects 28-34, wherein the silica fume comprises densified silica fume.

(36) The method of aspect 35, wherein the densified silica fume has a bulk density of from 500 kg/m³ to 900 kg/m³, e.g., from 450 kg/m³ to 800 kg/m³, such as from 600 kg/m³ to 700 kg/m³.

(37) The method of any one of aspects 28-36, wherein the core slurry contains silica fume in an amount of from 1% to 15% by weight of stucco, such as from 2% to 10% by weight of stucco, or from 3% to 5% by weight of stucco.

(38) The method of any one of aspects 28-37, wherein the core slurry is free of lime.

(39) The method of any one of aspects 28-37, wherein the core slurry is free of asbestos.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the disclosure but, of course, should not be construed as in any way limiting its scope.

### Example 1

This example demonstrates the physical properties of two silica fumes. The silica fumes were subjected to visual observation and Scanning Electron Microscope (“SEM”) observation.

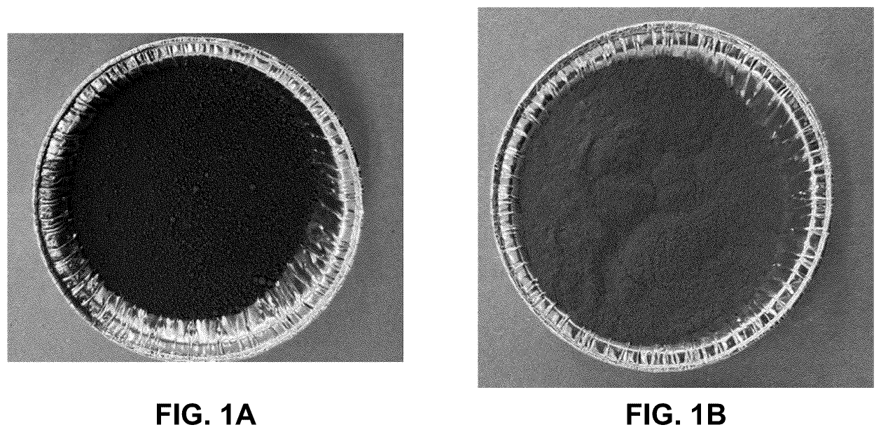

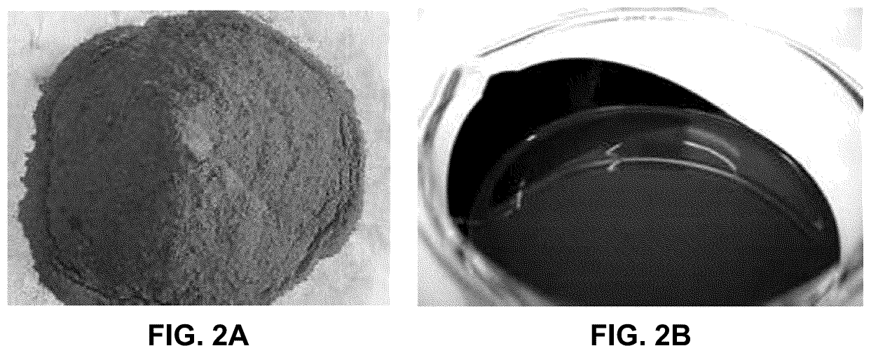

Two densified silica fumes in dry (i.e., powder) form were studied: Silica Fume 1A, which was a densified silica fume made by Norchem, Inc., headquartered in Hauppauge, New York, and Silica Fume 1B, which was made by Elkem, headquartered in Oslo, Norway. Silica Fumes 1A and 1B were sourced and studied “as-is,” i.e., without substantial physical or chemical modification. Photographs of Silica Fumes 1A and 1B are illustrated in FIGS. 1A and 1B, respectively.

As seen in FIGS. 1A and 1B, Silica Fume 1A demonstrates coarser particles and is darker in color than Silica Fume 1B inasmuch as silica Fume 1A is from ferrosilicon alloys while 1B is from silicon meta.

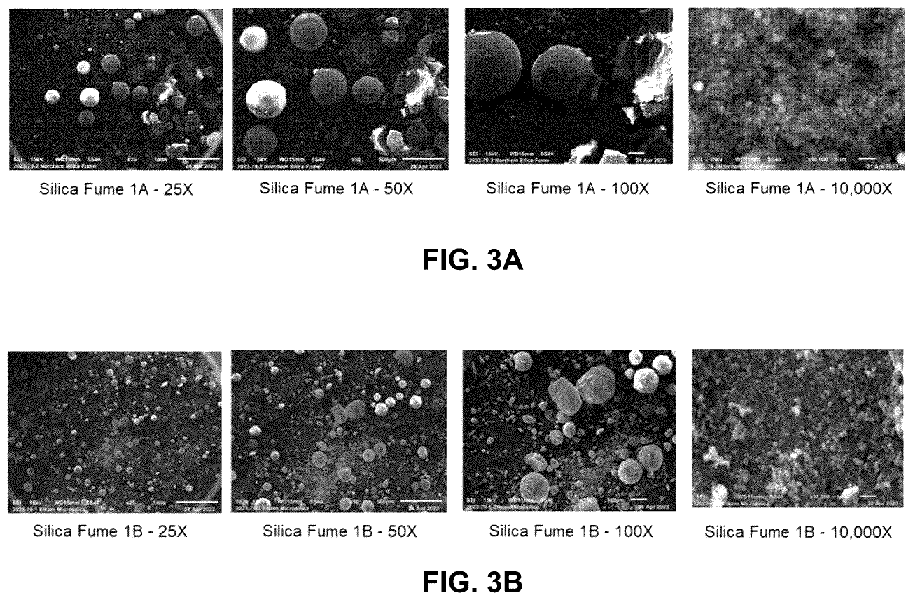

Silica Fumes 1A and 1B were studied by SEM under a range of magnifications (i.e., 25×, 50×, 100×, and 10,000×). Micrographs of the analysis are depicted in FIGS. 3A and 3B.

As seen in FIGS. 3A and 3B, Silica Fume 1A contains larger agglomerates than Silica Fume 1B due to their different densification processes.

### Example 2

This example demonstrates the effect of as-is densified silica fume on thermal shrinkage in gypsum compositions according to principles of embodiments of the disclosure.

Two sample boards were prepared and tested, identified below as Boards 2A and 2B, respectively. Board 2A was prepared as a control, i.e., without the inclusion of silica fume to the formulation. Board 2B was prepared with 17.5 grams (g) of silica fume (corresponding to 35 lbs/msf) in the form of densified silica fume commercially available from Norchem, Inc., as described in Example 1.

Boards 2A and 2B were prepared from slurries comprising stucco; heat-resistant additive (HRA); starch; glass fiber; sodium trimetaphosphate; retarder; dispersant, water, and foam in the amounts recorded in Table 1. The board weight (measured in lbs/msf) of Board 2A was 2018 lbs/msf and the board weight of Board 2B was 2037 lbs/msf. The boards had a thickness of 0.625″ and dimensions of 12″×13″.

In forming Board 2B, the dry densified silica fume was mixed with the powders. All powders and liquids were mixed in a 5-Quarter Hobart mixer, commercially available from Hobart Corporation, headquartered in Troy, Ohio. The slurry was prepared by soaking dry powders in the solution for 10 seconds and mixing for 10 seconds in the 5-Quarter Hobart mixer set at level 2, followed by injecting the foam into the slurry for 5 seconds and mixing another 2 seconds. The slurry was poured into the 12″×13″×⅝″ envelope. After the slurry was set and hardened, the samples were dried at 450° F. for 20 minutes, then moved to a 350° F. oven. After drying at 350° F. for 20 minutes, the board was further dried at 110° F. overnight.

Once mixed, the slurries for forming Boards 2A and 2B were poured into a 12″×13″×⅝″ envelope. Once poured, the slurries were then dried at 110° F. for 16 hours. Once dried, Board 2A and Board 2B were cut into 5″×5″×⅝″ portions. The thermal shrinkage properties of the samples were then tested at 1000° F. (538° C.), 1112° F. (600° C.), 1292° F. (700° C.), 1472° F. (800° C.), and 1600° F. (871° C.).

Table 1 depicts the formulations of Boards 2A and 2B.

TABLE 1

| | | Board 2B (containing |
|---|---|---|
| | Board 2A | Norchem densified silica |
| Ingredients | (Control) | fume (35 lbs/msf)) |
| Stucco (g) | 900 | 900 |
| HRA (g) | 9 | 9 |
| Starch (g) | 4 | 4 |
| Glass Fiber (g) | 4.5 | 4.5 |
| Densified Silica Fume | — | 17.5 |
| (g) | | |
| STMP (10% g) | 2 | 2 |
| Retarder (1% g) | 15 | 10 |
| Dispersant (g) | 4 | 4 |
| Water (g) | 780 | 790 |
| Foam (sec) | 6 | 6 |
| Board Weight | 2018 | 2037 |
| (lbs/msf) | | |

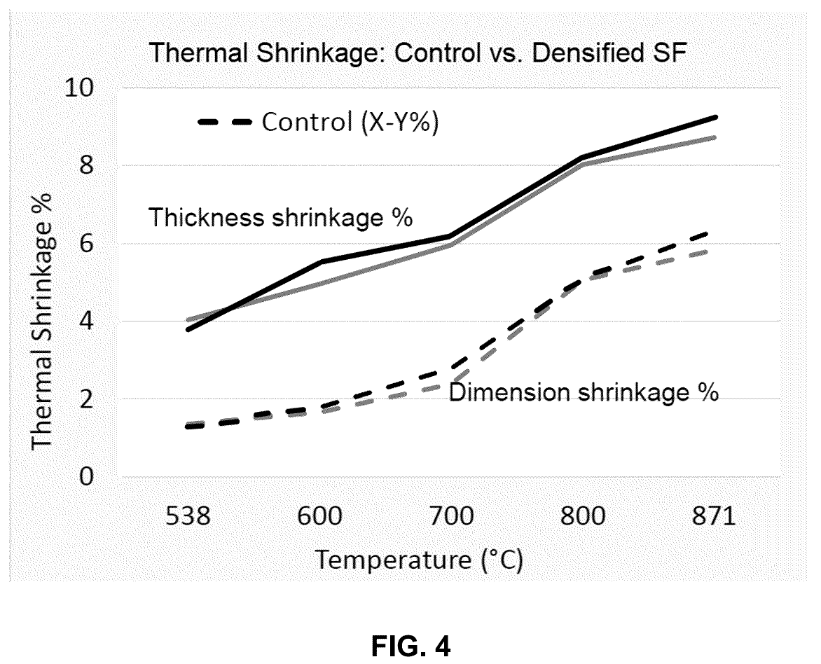

FIG. 4 depicts the results of thermal shrinkage testing on Boards 2A and 2B. In FIG. 4, thermal shrinkage (measured as a percentage) is charted along the Y-axis versus temperature (measured in ° F.) charted along the X-axis. Shrinkage along the x-y direction (width-length, X-Y %) and thickness (Z %) is depicted. As seen in FIG. 4, the inventors discovered that, surprisingly and unexpectedly, the direct addition of dry densified silica fume into the formulation does not lead to an evident reduction in shrinkage. While not wishing to be bound by any particular theory, it is believed that this is because the densified silica fume agglomerates cannot be dispersed by using a Hobart Mixer because the mixing energy is low.

### Example 3

This example demonstrates the effect of mixing in a high shear mixer on the dispersion of silica fume agglomerates from the densified silica fume from Norchem as described in Example 1.

To measure the effect various mixing approaches had on dispersion of silica fume agglomerates, the inventors prepared a slurry containing 16.7% of silica fume in water. The slurry was made by using a Ross HSM 100 LC high shear mixer, commercially available from Charles Ross & Son Company, headquartered at Hauppague, New York. The slurry was prepared in the high shear mixer at various different speeds and mixing times. Once mixed, two samples were taken from the top and the bottom of slurry right after mixing. The top and bottom samples were then collected. The top and bottom samples collected from the slurries were then studied at a magnification of 40× using a Pentaview liquid-crystal display (LCD) digital microscope, commercially available from Celestron, LLC, headquartered in Torrance, California.

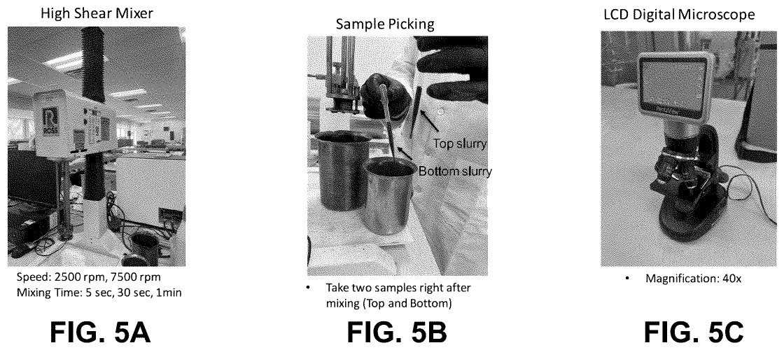

Six slurries were prepared to test the impact of mixer type, speed, and mixing time on the dispersion of silica fume agglomerates. Six slurries containing 16.7% silica fume in water were prepared using the high shear mixer under the following methods and conditions: (1) at 2500 rpm for 5 seconds; (2) at 2500 rpm for 30 seconds; (3) at 2500 rpm for 1 minute; (4) at 7500 rpm for 5 seconds; (5) at 7500 rpm for 30 seconds; and (6) at 7500 rpm for 1 minute. Top and bottom samples were then collected and studied under the LCD digital microscope. FIGS. 5A-5C illustrate the equipment used to conduct the test (e.g., the high shear mixer, top and bottom slurry collection, and the LCD microscope, respectively).

### Example 4

This example demonstrates the effect of high shear mixer on the dispersion of silica fume agglomerates in water. Comparative analysis of the performance of slurries prepared from silica fume sourced from Norchem and Elkem (as described in Example 1) was conducted.

In order to measure the effect of the high shear mixer on the silica fume agglomerate size and distribution, the inventors prepared slurries comprising either 16.7% of Norchem densified silica fume or 16.7% of Elkem densified silica fume.

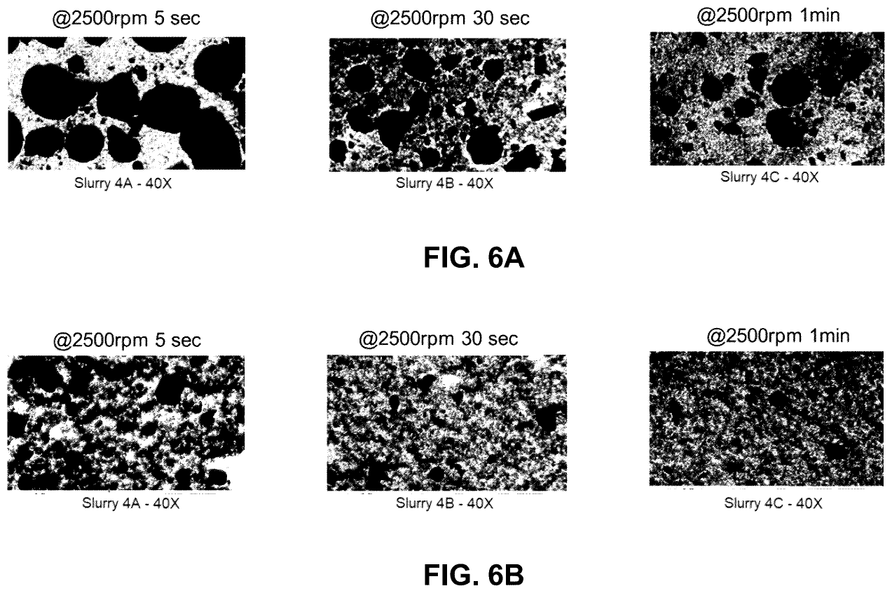

Twelve samples (referred to as Slurries 4A-4L) were prepared to test the impact of mixer type, speed, and mixing time on dispersion of silica fume agglomerates. Once mixed, portions from the top and bottom of each slurry were collected and studied under the LCD microscope. The results are depicted in FIGS. 6A-9B.

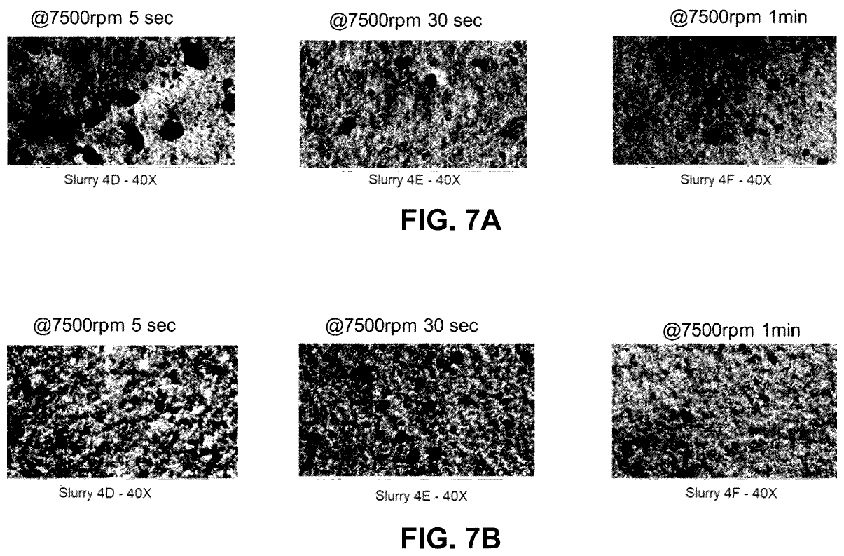

Specifically, six slurries were prepared from densified silica fume sourced from Norchem (FIGS. 6A-7B, referred herein as Slurries 4A-4F) using a high shear mixer. Each of Slurries 4A-4F had the same composition but were subjected to different conditions. In particular, Slurries 4A-4F were subjected to the following methods and conditions: at 2500 rpm for 5 seconds (Slurry 4A); at 2500 rpm for 30 seconds (Slurry 4B); at 2500 rpm for 1 minute (Slurry 4C); at 7500 rpm for 5 seconds (Slurry 4D); at 7500 rpm for 30 seconds (Slurry 4E); and at 7500 rpm for 1 minute (Slurry 4F).

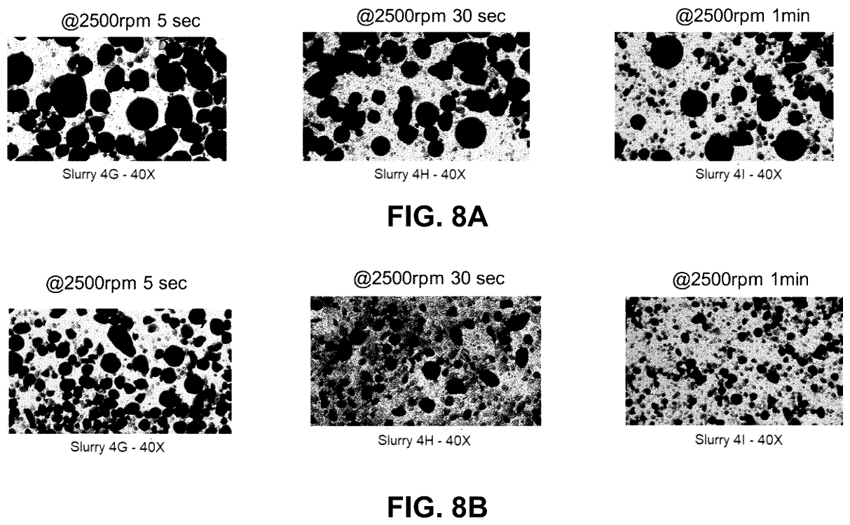

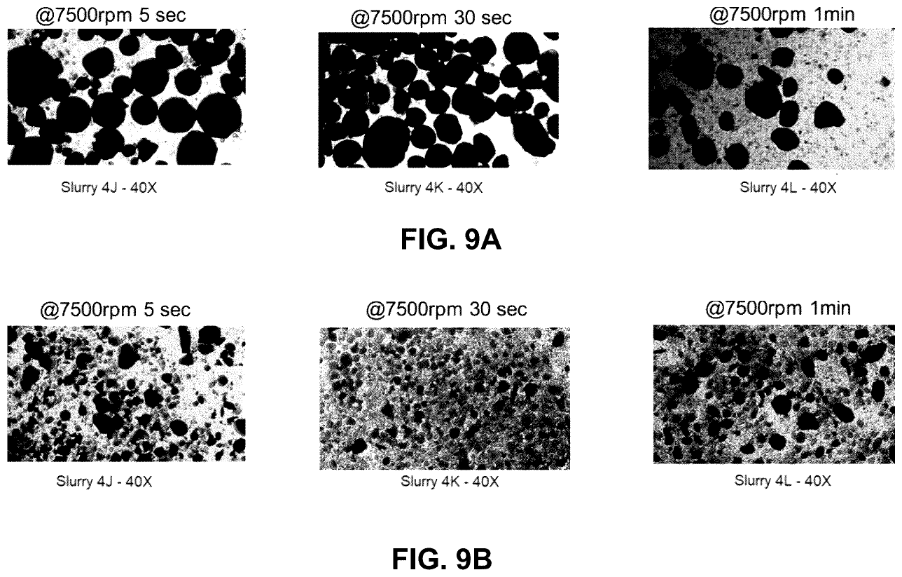

Six additional slurries were prepared from densified silica fume sourced from Elkem (FIGS. 8A-9B, referred to herein as Slurries 4G-4L) using a high shear mixer. Each of Slurries 4G-4L had the same composition but were subjected to different conditions. In particular, Slurries 4G-4L were subjected to the following methods and conditions: at 2500 rpm for 5 seconds (Slurry 4G); at 2500 rpm for 30 seconds (Slurry 4H); at 2500 rpm for 1 minute (Slurry 4I); at 7500 rpm for 5 seconds (Slurry 4J); at 7500 rpm for 30 seconds (Slurry 4K); and at 7500 rpm for 1 minute (Slurry 4L).

As seen in FIGS. 6A and 6B, the inventors discovered that the silica fume agglomerates in the slurry prepared from Norchem silica fume cannot be broken down within 1 minute at 2500 rpm in a high shear mixer (i.e., Slurries 4A-4C). As seen in FIGS. 7A and 7B, the inventors discovered that the Norchem silica fume agglomerates can be broken down within 1 minute at 7500 rpm (i.e., Slurries 4D-4F).

Regarding the Elkem silica fume slurries, as seen in FIGS. 8A and 8B, the inventors discovered that, when subjected to the same conditions in a high shear mixer, the silica fume agglomerates in the slurry prepared from Elkem silica fume cannot be broken down within 1 minute at 2500 rpm (i.e., Slurries 4G-4I). In addition, as seen in FIGS. 9A and 9B, the inventors also discovered that particles tend to clump at the bottom of the Elkem silica fume slurry when mixed at 7500 rpm (i.e., Slurries 4J-4L). As a result, the inventors discovered that a low speed of 2500 rpm appears to be advantageous for breaking down Elkem silica fume agglomerates.

### Example 5

This example compares thermal shrinkage properties in gypsum compositions according to principles of embodiments of the disclosure. In particular, three slurries were tested for thermal shrinkage properties as discussed below.

Gypsum boards were prepared following the formulations depicted in Table 2, identified below as Boards 5A, 5B, and 5C. Board 5A was prepared as a control sample, without the inclusion of silica fume in the gypsum slurry. Boards 5B and 5C were prepared from slurries containing 16.7% densified silica fume in water. The slurries were prepared at 2500 rpm for 1 minute in the high shear mixer. For comparative analysis, the densified silica fume used for Board 5B was sourced from Norchem while the densified silica fume sourced for Board 5C was sourced from Elkem.

In addition, Boards 5A-5C were prepared from slurries comprising stucco; HRA; starch; glass fiber; STMP; retarder; dispersant, water, and foam in the amounts depicted in Table 2. The board weights for each of Boards 5A-5C (measured in lbs/msf) were 2276, 2298, and 2321, respectively, and the board dimensions were 12″×13″ with a thickness of ⅝″. After drying, the boards were cut into 5″×2″×⅝″ samples for the shrinkage tests.

Table 2 depicts the formulations of Boards 5A-5C.

TABLE 2

| | 5A: | 5B: | 5C: |
|---|---|---|---|
| Ingredient | Control | Norchem | Elkem |
| Stucco (g) | 900 | 900 | 900 |
| HRA (g) | 9 | 9 | 9 |
| Starch (g) | 4 | 4 | 4 |
| Glass Fiber (g) | 4.5 | 4.5 | 4.5 |
| 16.7% Silica Fume | — | 120 | 120 |
| Slurry (g) | | | |
| STMP (10% g) | 2 | 2 | 2 |
| Retarder (1% g) | 15 | 10 | 10 |
| Dispersant (g) | 4 | 4 | 4 |
| Water (g) | 780 | 690 | 690 |
| Foam (sec) | 5.5 | 5.5 | 5.5 |
| Board Weight | 2276 | 2298 | 2321 |
| (lbs/msf) | | | |

Boards 5A-5C were subjected to calcination to measure the silica fume's performance properties. To perform the comparative calcination, a furnace was first preheated to 900° C. The board samples were heated in the furnace for 30 minutes (Table 3A), 20 minutes (Table 3B), and 10 minutes (Table 3C) to test thermal shrinkage properties. Once heated, the results were then recorded and compared.

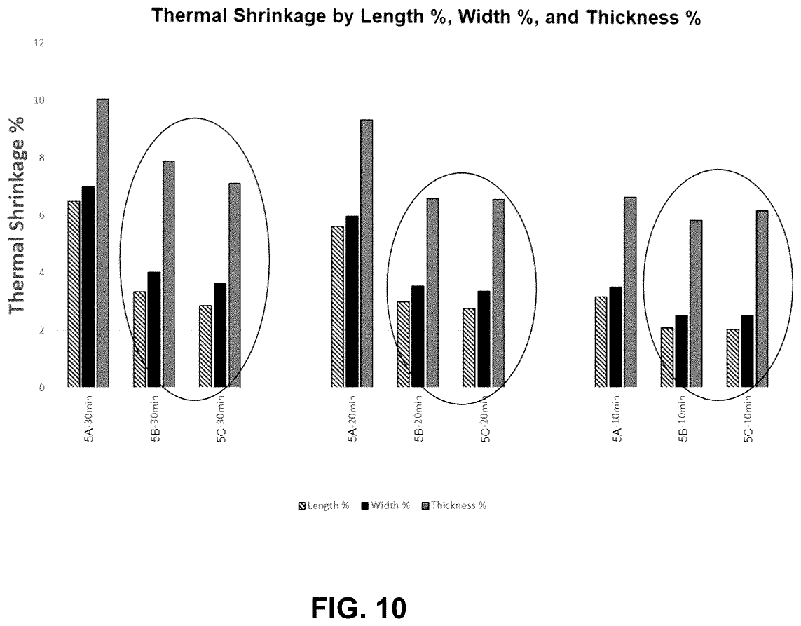

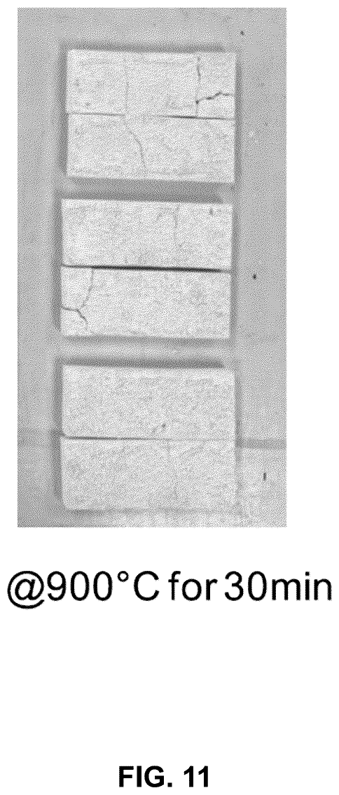

Tables 3A-3C depict the results of testing Boards 5A-5C. The results are also depicted in FIG. 10.

TABLE 3A

| Board | Calcination Time | Length % | Width % | Thickness % |
|---|---|---|---|---|
| 5A | 30 minutes | 6.49% | 6.99% | 10.04% |
| 5B | 30 minutes | 3.35% | 4.02% | 7.90% |
| 5C | 30 minutes | 2.87% | 3.64% | 7.11% |

TABLE 3B

| Board | Calcination Time | Length % | Width % | Thickness % |
|---|---|---|---|---|
| 5A | 20 minutes | 5.62% | 5.97% | 9.33% |
| 5B | 20 minutes | 2.99% | 3.55% | 6.59% |
| 5C | 20 minutes | 2.77% | 3.37% | 6.56% |

TABLE 3C

| Board | Calcination Time | Length % | Width % | Thickness % |
|---|---|---|---|---|
| 5A | 10 minutes | 3.18% | 3.51% | 6.63% |
| 5B | 10 minutes | 2.09% | 2.51% | 5.84% |
| 5C | 10 minutes | 2.03% | 2.52% | 6.17% |

FIG. 10 depicts the results of the thermal shrinkage and calcination testing performed on Boards 5A-5C, categorized by overall calcination time (30 minutes, 20 minutes, and 10 minutes). In FIG. 10, thermal shrinkage is measured as a percentage in terms of Length %, Width %, and Thickness %. The bar graph depicted in FIG. 10 incorporates the percentage values collected in Tables 3A-3C.

As seen in Tables 3A-3C, as well as FIG. 10, the inventors discovered that, surprisingly and unexpectedly, the addition of the dispersed silica fume slurry prepared at 2500 rpm for 1 minute in the high shear mixer greatly reduces thermal shrinkage as compared with the control slurry. In this respect, both the silica fume slurries sourced from Norchem and Elkem exhibited comparable enhancements in thermal shrinkage performance.

### Example 6

This example demonstrates the effect of mixing time at 2500 rpm on thermal shrinkage at various temperature in gypsum compositions according to principles of embodiments of the disclosure.

Gypsum boards were prepared in accordance to the formulations depicted in Table 4 below. In particular, five boards were prepared and tested, identified as Boards 6A-6E. Comparative analysis of Boards 6A-6E was conducted by means of measuring calcination performance results of various boards formed from dry densified silica fume or slurries prepared at 2500 rpm for different mixing time. Board 6A was prepared as a control sample, while Boards 6B-6E were prepared from gypsum slurries comprising silica fume sourced from Elkem. The boards were also tested with different forms of silica fume. For example, Boards 6B was prepared with dry densified silica fume, while Boards 6C-6E were prepared from slurries containing 16.7% silica fume in water.

In addition, the slurries used to form Boards 6A-6E comprised stucco; heat-resistant additive; starch; glass fiber; sodium trimetaphosphate; retarder; dispersant, water, and foam. The board weights (measured in lbs/msf) of Boards 6A-6E were 2193, 2213, 2240, 2203, and 2206, respectively. The ingredients were added and measured in accordance with the measurements provided in Table 4.

Control Board 6A was mixed in the Hobart mixer (including the powder and liquid). For Board 6B, the powder included the dry densified silica fume. For Boards 6C-6E, the slurries containing 16.7% silica fume in water were made at 2500 rpm for 3 seconds (Board 6C), 6 seconds (Board 6D), or 60 seconds (Board 6E). Afterward, the slurries for Boards 6C-6E were transferred to the Hobart mixer and mixed with the wet and dry ingredients. Each of Boards 6A-6E had dimensions of 12″×13″ and a thickness of ⅝″. After drying, the boards were cut into 5″×2″×⅝″ samples for the shrinkage tests.

Table 4 depicts the formulations of Boards 6A-6E.

TABLE 4

| | High Shear Mixer at 2500 rpm | | | | |
|---|---|---|---|---|---|
| Ingredient | 6A | 6B | 6C | 6D | 6E |
| Sample ID | Control | Dry | HS-3 | HS-6 | HS-60 |
| | | SF | sec | sec | sec |
| Stucco (g) | 900 | 900 | 900 | 900 | 900 |
| HRA (g) | 9 | 9 | 9 | 9 | 9 |
| Starch (g) | 4 | 4 | 4 | 4 | 4 |
| Glass Fiber (g) | 4.5 | 4.5 | 4.5 | 4.5 | 4.5 |
| Elkem Microsilica ® | | 20.5 | | | |
| 940 | | | | | |
| 16.7% Silica Fume | | | 120.5 | 120.5 | 120.5 |
| Slurry (g) | | | | | |
| STMP (10% g) | 2 | 2 | 2 | 2 | 2 |
| Retarder (1% g) | 15 | 10 | 10 | 10 | 10 |
| Dispersant (g) | 4 | 4 | 4 | 4 | 4 |
| Water (g) | 780 | 780 | 690 | 690 | 690 |
| Foam (sec) | 5.5 | 5.5 | 5.5 | 5.5 | 5.5 |
| Board Weight (lbs/msf) | 2193 | 2213 | 2240 | 2203 | 2206 |

Once mixed, the boards were then calcined and measured at 650° C., 800° C., and 900° C. for 30 minutes. The results are set forth in Tables 5A, 5B, and 5C. Table 5A records the thermal shrinkage results for Boards 6A-6E when calcined at 900° C. for 30 minutes. Table 5B records the thermal shrinkage results for Boards 6A-6E when calcined at 800° C. for 30 minutes. Table 5C records the thermal shrinkage results for Boards 6A-6E when calcined at 650° C. for 30 minutes.

TABLE 5A

| | Calcination | | |
|---|---|---|---|
| Board | Temperature | Area % | Thickness % |
| 6A | 900° C. | 5.30% | 9.62% |
| 6B | 900° C. | 5.29% | 9.53% |
| 6C | 900° C. | 4.51% | 9.08% |
| 6D | 900° C. | 4.43% | 9.02% |
| 6E | 900° C. | 4.25% | 8.22% |

TABLE 5B

| | Calcination | | |
|---|---|---|---|
| Board | Temperature | Area % | Thickness % |
| 6A | 800° C. | 3.32% | 7.18% |
| 6B | 800° C. | 3.28% | 6.95% |
| 6C | 800° C. | 2.90% | 6.56% |
| 6D | 800° C. | 2.80% | 6.49% |
| 6E | 800° C. | 2.49% | 5.85% |

TABLE 5C

| | Calcination | | |
|---|---|---|---|
| Board | Temperature | Area % | Thickness % |
| 6A | 650° C. | 2.56% | 6.44% |
| 6B | 650° C. | 2.57% | 6.51% |
| 6C | 650° C. | 2.56% | 6.28% |
| 6D | 650° C. | 2.59% | 6.01% |
| 6E | 650° C. | 2.49% | 5.56% |

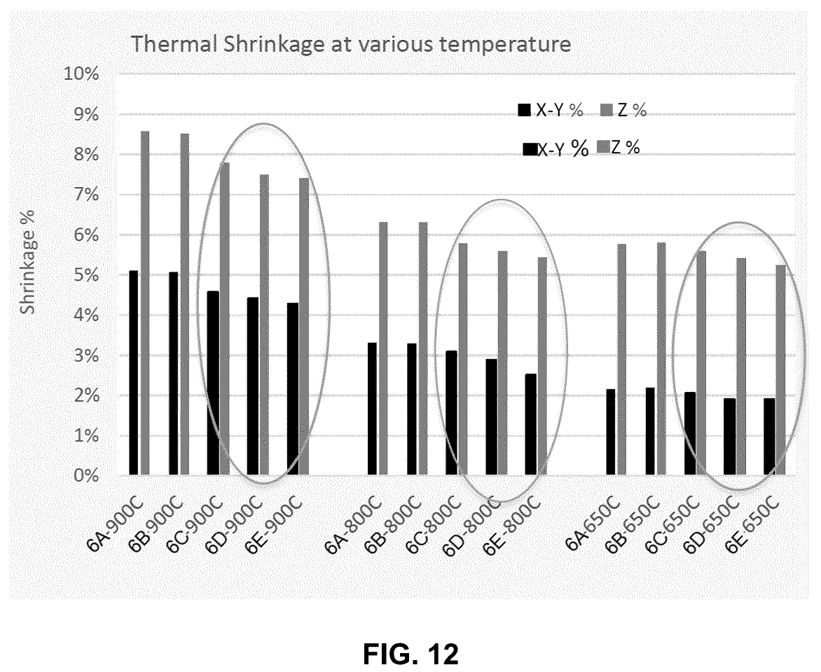

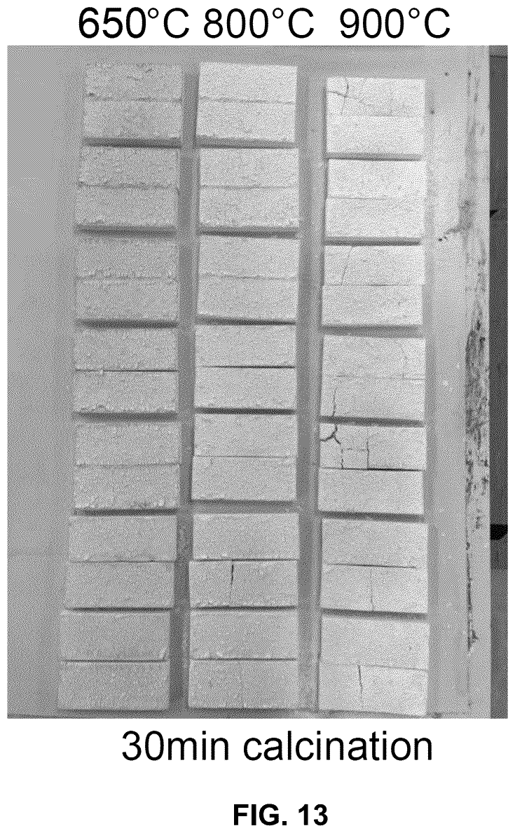

FIG. 12 depicts the results of the thermal shrinkage and calcination testing performed on Boards 6A-6E, categorized by overall calcination temperature (900° C., 800° C., and 650° C.). FIG. 12 is a bar graph of Thermal Shrinkage (%) along the x-y direction (width-length) and z direction (thickness) of Boards 6A-6E. The bar graph depicted in the FIG. 12 incorporates the percentage values collected in Tables 5A-5C. FIG. 13 is a photograph of the boards after testing at 650° C., 800° C., and 900° C.

As seen in Tables 5A-5C and in FIGS. 12 and 13, the inventors discovered that, surprisingly and unexpectedly, using a silica fume slurry instead of dry silica fume particles particularly reduces shrinkage. For example, the shrinkage demonstrated by Boards 6C, 6D and 6E are better than control Board 6A and Board 6B containing the dry silica fume particles. In addition, the inventors discovered that longer mixing time of silica fume slurry at 2500 rpm improves shrinkage (as seen in the results for Board 6E<Board 6D<Board 6C). Therefore, the inventors found that increasing mixing time to at least 2500 rpm is desirable.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Stucco and water are fundamental ingredients in a slurry and are thus not considered additives. When amounts are compared between the core and dense layer slurries, it will be understood that it is in relation to a relative comparison, i.e., concentration. To the extent that some portions of the description may refer to the primary and secondary discharge conduits as integral to the board mixer and other portions may refer to them as separate pieces, it will be understood that any such difference in description does not suggest or imply different arrangements unless otherwise indicated. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. All amounts are by weight and not by volume, unless otherwise indicated. Variations of those preferred embodiments can become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising:
a set gypsum core disposed between two cover sheets, the core formed from a core slurry comprising water, stucco, and silica fume;
the gypsum board meeting at least one or more of the following tests (a)-(d):
(a) a High Temperature Shrinkage(S) of about 10% or less in the z direction when heated to about 1560° F. (850° C.), according to ASTM C1795-15;
(b) a High Temperature Shrinkage(S) of about 10% or less in the x-y directions (width-length) when heated to about 1560° F. (850° C.) according to ASTM C1795-15;
(c) a Thermal Insulation Index (TI) of about 20 minutes or greater according to ASTM C1795-15; and/or
(d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

2. The gypsum board of claim 1, wherein the slurry is substantially free from vermiculite, asbestos, or lime.

3. The gypsum board of claim 1, wherein the silica fume is added to the slurry in the form of a silica fume slurry comprising water and silica fume particles.

4. The gypsum board of claim 1, wherein the silica fume slurry contains from 10% to 50% silica fume.

5. The gypsum board of claim 1, wherein the silica fume comprises undensified silica fume.

6. The gypsum board of claim 1, wherein the silica fume comprises densified silica fume.

7. The gypsum board of claim 1, wherein the core slurry contains silica fume in an amount of from 1% to 15% by weight of stucco.

8. A method of making gypsum board, the method comprising:
mixing a core slurry comprising stucco, water, and silica fume;
placing the slurry between two cover sheets to form a board precursor;
allowing the slurry in the precursor to set to form the board; and
cutting the board, wherein the board meets at least one or more of the following tests (a)-(d):
(a) a High Temperature Shrinkage(S) of about 10% or less in the z direction when heated to about 1560° F. (850° C.), according to ASTM C1795-15;
(b) a High Temperature Shrinkage(S) of about 10% or less in the x-y directions (width-length) when heated to about 1560° F. (850° C.) according to ASTM C1795-15;
(c) a Thermal Insulation Index (TI) of about 20 minutes or greater according to ASTM C1795-15; and/or
(d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

9. The method of claim 8, further comprising mixing a silica fume slurry comprising silica fume particles and water, wherein the silica fume is mixed into the core slurry in the form of the silica fume slurry.

10. The method of claim 8, wherein the silica fume slurry contains from 10% to 50% silica fume.

11. The method of claim 8, wherein the silica fume comprises undensified silica fume.

12. The method of claim 8, wherein the silica fume comprises densified silica fume.

13. The method of claim 8, wherein the core slurry contains silica fume in an amount of from 1% to 15% by weight of stucco.

14. The method of claim 8, wherein the core slurry is free of lime or asbestos.

15. A method of making gypsum board, the method comprising:
mixing a silica fume slurry comprising silica fume particles and water, wherein the silica fume is mixed into the core slurry in the form of the silica fume slurry, e.g., prepared in a high shear mixer;
mixing a core slurry comprising stucco, water, and the silica fume slurry;
placing the slurry between two cover sheets to form a board precursor;
allowing the slurry in the precursor to set to form the board; and
cutting the board, wherein the board meets at least one or more of the following tests (a)-(d):
(a) a High Temperature Shrinkage(S) of about 10% or less in the z direction when heated to about 1560° F. (850° C.), according to ASTM C1795-15;
(b) a High Temperature Shrinkage(S) of about 10% or less in the x-y directions (width-length) when heated to about 1560° F. (850° C.) according to ASTM C1795-15;
(c) a Thermal Insulation Index (TI) of about 20 minutes or greater according to ASTM C1795-15; and/or
(d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than about 325° F. plus ambient temperature after about 60 minutes; or an average value of the temperature sensors is less than about 250° F. plus ambient temperature after about 60 minutes.

16. The method of claim 15, wherein the silica fume slurry contains from 10% to 50% silica fume.

17. The method of claim 15, wherein the silica fume comprises undensified silica fume.

18. The method of claim 15, wherein the silica fume comprises densified silica fume.

19. The method of claim 15, wherein the core slurry contains silica fume in an amount of from 1% to 15% by weight of stucco.

20. The method of claim 15, wherein the core slurry is free of lime or asbestos.
